(19) United States
(12) Patent Application Publication
(10) Pub. No.: US 2025/0238515 A1
(43) Pub. Date: Jul. 24, 2025

(54) AUTOMATED FIRMWARE ANALYSIS AND REPORTING TOOL

(71) Applicant: Saudi Arabian Oil Company, Dhahran (SA)

(72) Inventor: John Gwilliams, Dhahran (SA)

(21) Appl. No.: 18/416,528

(22) Filed: Jan. 18, 2024

(51) Int. Cl. G06F 21/57

(52) U.S. Cl. CPC G06F 21/572

(57) ABSTRACT

The present disclosure relates to computer-implemented methods, software, and systems for automatic security assessment of firmware. A source firmware file can be obtained. Content from the file can be extracted. A plurality of files can be stored based on the extracted content, where the plurality of files are respectively dedicated to different data types. Security test algorithms can be executed over the plurality of files based on each data type specific to each file of the plurality of files. The security test algorithms comprise one or more security test algorithms specific to each different data type. Test execution results can be obtained based on the executed security test algorithms. The test execution results can be evaluated and a report comprising a security risk status for the source firmware file is provided for display.

### TECHNICAL FIELD

The present disclosure relates to computer-implemented methods, software, and systems for data processing.

### BACKGROUND

Firmware is a microcode or program that can be embedded into the memory of hardware devices as control software to support their operations. Firmware can be embedded in hardware devices, cameras, mobile devices, computers, servers, optical drives, printers, routers, scanners, and television remotes, among other examples. The firmware enables the devices to operate and provide suitable functionalities.

### SUMMARY

The present disclosure involves systems, software, and computer implemented methods for automatic security assessment of firmware.

One example method may include operations such as: obtaining a source firmware file; extracting content from the source firmware file and storing a plurality of files based on the extracted content, wherein the plurality of files comprises files respectively dedicated to different data types; executing security test algorithms over the plurality of files based on each data type specific to each file of the plurality of files, wherein the security test algorithms comprise one or more security test algorithms specific to each different data type; evaluating test execution results obtained based on the executed security test algorithms; and providing a report for display at a display device, the report comprising a security risk status for the source firmware file determined based on the evaluation.

In some instances, extracting content from the source firmware file can include determining a list for discrete components identifiable by data type. The list can include data for each discrete component comprising a starting point, an offset, and description. The extraction of content can include extraction of the discrete components from the source firmware file to be stored as the plurality of files based on the determined list.

In some instances, providing the report can include: automatically generating the report based on one or more rules to structure and aggregate data provided from the evaluation of the test execution results and to generate the security risk status for the source firmware file; and providing the report as a file for downloading via interaction with the display.

In some instances, extracting the content from the source firmware file can include: recursively extracting of components of the source firmware file. One or more of the components can be nested into a parent component of the components. The recursive extracting can include determining whether the source firmware file is in a compressed form to execute decompression of the source firmware file to enable the recursive extraction.

In some instances, executing the security test algorithms can include: analyzing each of the plurality of files based on unique characteristics determined as related to a respective data type of one or more files of the plurality of files. The analyzing can include identifying one or more security tests relevant for a first data type, and executing the one or more security tests for each of the first data types as a separate discrete process from a process for executing one or more other security tests for other files of another, second data type.

In some instances, evaluating the test execution results can include identifying security alerts associated with at least one of the plurality of files.

In some instances, evaluating the test execution results can include that based on identifying security alerts associated with one or more files of the plurality of files, the plurality of files are mounted as a filesystem at a local mount point to perform local audit of the filesystem, permissions, versions, and configuration files to determine security issues in the mounted filesystem.

In some instances, the determined security issues comprise misconfigurations in the filesystem related to setting permissions and/or insecure network communication channels.

Similar operations and processes may be performed in a system comprising at least one processor and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. In other words, while generally described as computer implemented software embodied on tangible, non-transitory media that processes and transforms the respective data, some or all of the aspects may be computer implemented methods or further included in respective systems or other devices for performing this described functionality.

It is appreciated that methods, in accordance with the present disclosure, can include any combination of the aspects and features described herein. That is, methods in accordance with the present disclosure are not limited to the combinations of aspects and features specifically described herein, but also include any combination of the aspects and features provided.

Various implementations of the technology described herein may provide one or more of the following advantages. In some instances, the technology described herein can support automated security testing of firmware. A thorough security screening can be provided by accessing the content of the firmware file(s) and considering the content data types. Since firmware can be control software, the firmware should be scrutinized under a high security level, for example, corresponding to the level of cyber security scrutiny for workstations and server operating systems. Since firmware can be provided “as is” for a device to run, it may not be possible to install security agents to evaluate it before installation. The described systems and techniques provide an interface that allows a detailed degree of access to the content items of firmware. Firmware can be evaluated according to a defined test suite, including specific tests for different data types of the content items. Such security test assessment can be executed efficiently, as a single synchronized process. Further, the security test assessment of the firmware can be executed on a handheld device that implements logic for extracting, evaluating, and running relevant tests for the content items of the firmware according to the data type. In some cases, a device can support rapid and automated end-user triggered analysis of firmware risks “in the palm of a user's hand.”

In some instances, the security test assessment of the firmware can be supported for execution in an “offline” mode, for example, on a standalone hand-held device or through a native application on a computing device (e.g., tablet, laptop, phone, etc.). By executing the assessment in such “offline” mode, the data processing is maintained within the device environment and is not sent to third parties and/or does not rely on the exchange of data with external resources. Thus, the exposure of the tested firmware to external parties (e.g., services provided through a network) is minimized, which supports a secure manner of testing that reduces risks of security breaches through external services. Additionally, performing the security assessment in an “offline” mode can promote fast security assessment that is independent of network signal or connectivity strength.

In some instances, the security test assessment of the firmware can be integrated with or within corporate vulnerability management platforms to improve a corporate system environment. In some cases, security test assessment can be implemented as a service, accessible through a corporate vulnerability management platform of an entity (e.g., as a component or add-on of the platform, or as a part of a cloud platform solution) and can be used to update corporate systems based on executed security tests. In some instances, the updates can be performed based on real-time executed testing that can dynamically provide instructions or notifications for changes, modifications, or additions to one or more of the corporate systems and/or configurations.

The details of these and other aspects and embodiments of the present disclosure are set forth in the accompanying drawings and the description below. Other features, objects, and advantages of the disclosure will be apparent from the description, the drawings, and the claims.

### DESCRIPTION OF DRAWINGS

FIG. 1 illustrates an example computer system architecture for assessing security risk of firmware files.

FIG. 2A is a block diagram of an example method for evaluating security risks associated with a source firmware file in accordance with implementations of the present disclosure.

FIG. 2B is a block diagram of an example method for processing source firmware in accordance with implementations of the present disclosure.

FIG. 3 is a block diagram of a handheld device configured to evaluate security risks associated with a source firmware file provided by a user in accordance with implementations of the present disclosure.

FIG. 4 is a flowchart of an example method for analyzing content of a source firmware file to determine security issues in accordance with implementations of the present disclosure.

FIG. 5 is a schematic illustration of example computer systems that can be used to execute implementations of the present disclosure.

### DETAILED DESCRIPTION

The present disclosure describes various tools and techniques for assessing security issues that may be associated with firmware. The technology generally relates to automated unpacking of firmware to extract identifiable components and to apply security tests relevant for each of the data types identified in the firmware. The components identified in the firmware can be extracted and stored as distinct files. In some implementations, the files can be sorted based on their data type so that applicable algorithms can be run as discrete processes for files of each of the data types. The processing that is executed during the security testing can be unique to the type of data. In some implementations, a report can be provided with a risk rating. The report can be displayed on a user display. The present disclosure supports prompt execution of a security assessment of firmware, for example, in the context of assessing a new version of firmware to be released for productive use, or for assessing legacy firmware and compliance with a security standard. In some cases, the standard for accessing the firmware can be a different standard from a previous security standard or additionally applied for the firmware security assessment.

In some instances, a hardware tool such as, for example, a self-contained handheld device can be implemented for performing security risk evaluation and providing results in a report that can include a security risk status determined for the firmware. In some implementations, the report can be presented in a format that is understandable for non-specialists. In some instances, the hardware tool can be a stand-alone tool that can efficiently evaluate the firmware without requesting external services and relying on a security test suite that combines tests relevant for different data types.

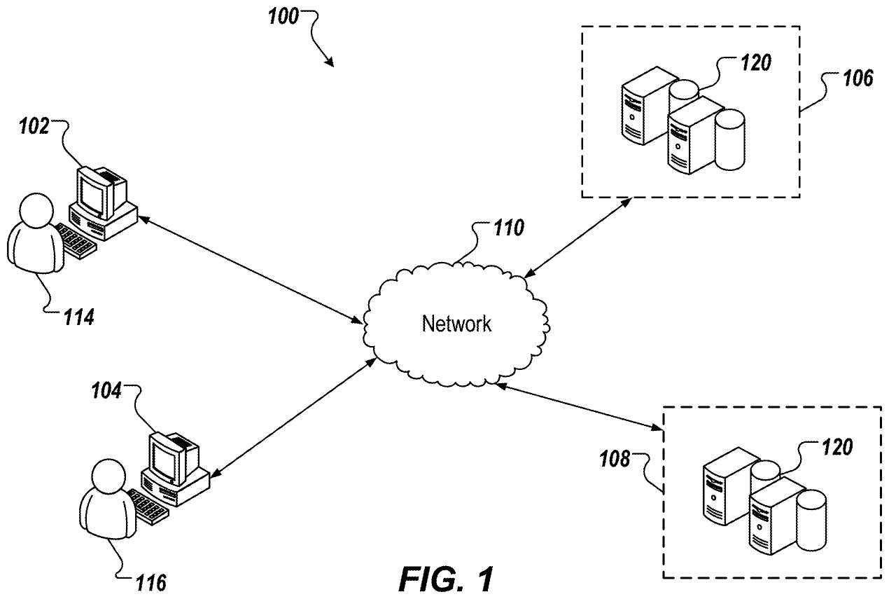

FIG. 1 depicts an example architecture 100 in accordance with implementations of the present disclosure. In the depicted example, the example architecture 100 includes a client device 102, a client device 104, a network 110, an environment 106, and an environment 108. The environment 106 and the environment 108 may be a cloud environment. The environment 106 and the environment 108 may include corresponding one or more server devices and databases (e.g., processors, memory). In the depicted example, a user 114 interacts with the client device 102, and a user 116 interacts with the client device 104.

In some examples, the client device 102 and/or the client device 104 can communicate with the environment 106 and/or environment 108 over the network 110. The client device 102 can include any appropriate type of computing device such as a desktop computer, a laptop computer, a handheld computer, a tablet computer, a personal digital assistant (PDA), a cellular telephone, a network appliance, a camera, a smartphone, an enhanced general packet radio service (EGPRS) mobile phone, a media player, a navigation device, an email device, a game console, or an appropriate combination of any two or more of these devices, or other data processing devices. In some implementations, the network 110 can include a large computer network, such as a local area network (LAN), a wide area network (WAN), the Internet, a cellular network, a telephone network (e.g., PSTN), or an appropriate combination thereof connecting any number of communication devices, mobile computing devices, fixed computing devices and server systems.

In some implementations, the environment 106 includes at least one server and at least one data store 120. In the example of FIG. 1, the environment 106 is intended to represent various forms of servers including, but not limited to a web server, an application server, a proxy server, a network server, and/or a server pool. In general, server systems accept requests for application services and provides such services to any number of client devices (e.g., the client device 102 over the network 110) and other service requests, as appropriate.

In some instances, the environments 106 and 108 may host one or more client applications, application servers, and authorization servers to support execution of secure requests between the client applications and the application server. In some instances, the users 114 and/or 116 may access a client application through the network 110. In some instances, the environments 106 and/or 108 can implement logic for performing security risk assessment for firmware, for example, provided by a user (e.g., through uploading, or via a link or reference, among other examples). The firmware that can be accessed, may be firmware that is to be installed on a user device, for example, on one of the client devices 102 or 104.

In some instances, the client devices 102 and/or 104 can host logic for performing security risk assessment for firmware in accordance with embodiments of the present disclosure. For example, the client devices 102 and/or 104 can be handheld devices that can be used by the users 114 and/or 116 to access firmware (e.g., a new version of firmware, legacy firmware, other) for associated security issues that can be evaluated to determine a security risk status for the firmware. In some instances, the client devices 102 and/or 104 can provide security risk assessment for firmware that is to be installed on other devices that may or may not be associated with the network 110.

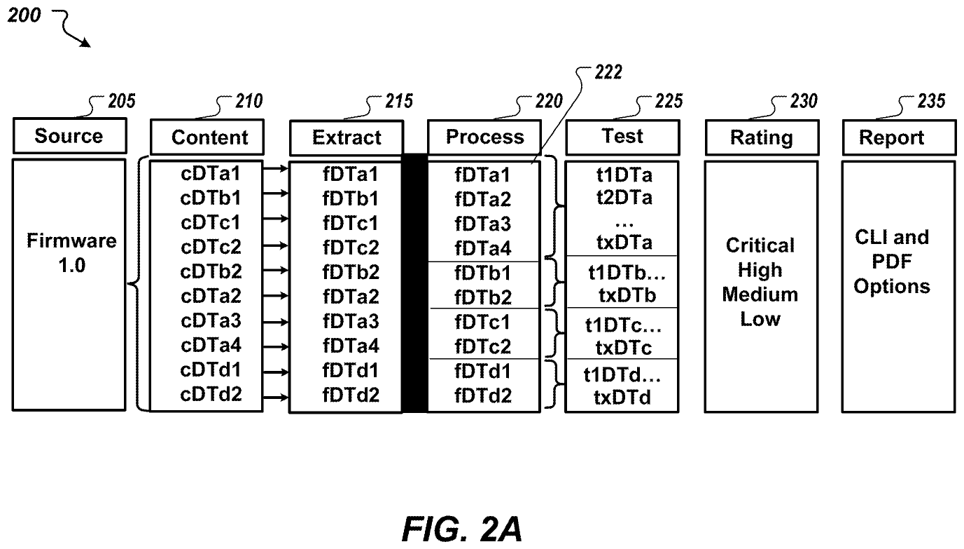

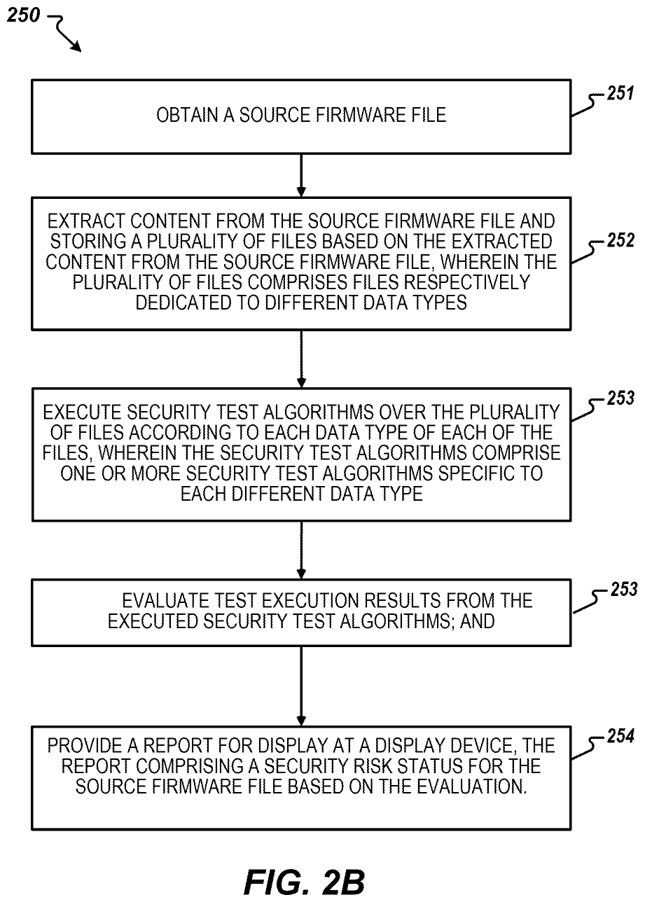

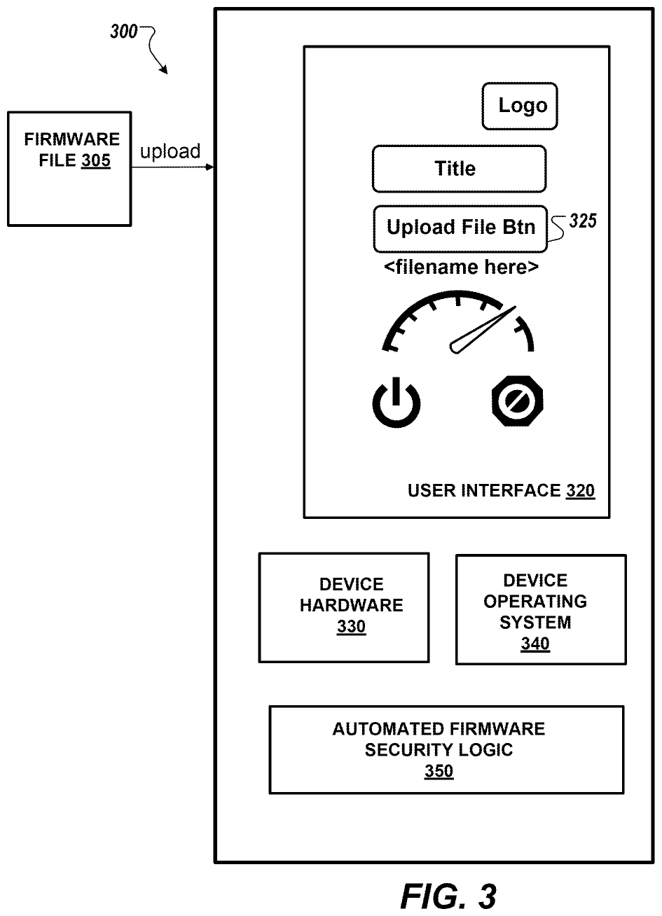

FIG. 2A is a block diagram for an example method 200 for evaluating security risks associated with a source firmware file 205 in accordance with implementations of the present disclosure. In some implementations, the example method 200 can be implemented as software running on hardware, and can be provided as a service accessible over a network or as a mobile standalone device (e.g., as described in relation to FIG. 3).

In some implementations, the example method 200 can be implemented as an automated tool that executes multiple operations associated with a security risk analysis of a provided firmware as source 205. The source firmware 205 can be a file of a particular type and can have a file extension. In some instances, the file extension can be evaluated to determine whether the source firmware 205 file was generated by employing one or more compression algorithms. In cases where the source firmware 205 is a compressed file, automated decompression can be executed to extract content.

In some implementations, the source firmware 205 can be obtained, and content 210 can be analyzed (e.g., recursively) to identify distinct content items. In some implementations, content types can be extracted one after another, and for each one, it can be determined whether further recursive extraction is needed to identify all content items of the source firmware. By analyzing the content of the source firmware 205, data types for the content items can be determined. The source firmware 205 (e.g., “Firmware 1.0”) can be analyzed to produce a content list split into discrete items identifiable by their data type (DTa, DTb, DTc, etc.), a numbered counter (1 . . . x), and a prefix “c” for Content. For example, cDTal may be the first content block (e.g., of privacy enhanced mail (PEM) data type) and cDTd4 may be the fourth content block (e.g., of zLib data type).

In some implementations, identified content items from the content 210 are extracted as extracted files 215. At 220, each extracted component in a file can be analyzed based on unique characteristics of the content, such as the data type of the file, and tests 225 can be executed to identify security alerts. In some instances, security alerts can be associated with a security risk level, where multiple security risk levels can be defined and used to identify and categorize security risk determinations. An example of a security alert that can be identified as associated with a high security risk level (e.g., above a first threshold level defined for high security risk) can include an alert for unprotected private key material(s) that can be extracted and used to impersonate the vendor. An example of a security alert that can be identified as associated with a medium-to-high security risk level, can include an alert for the identification of hardcoded credentials for either the management portal, SSH login, or other embedded components. For example, the medium-to-high security risk level can be defined for risk issues that are with a risk level within a threshold range defined between a second threshold level associated with medium risk levels and a third risk level that is predefined (e.g., at a threshold distance above the first threshold level defined as the lower range-end for the high security risk). An example of a security alert that can be identified as associated with a low security risk level can include an alert raised for details of application content for management interface configured inside the firmware, or the ability to identify internal binary files that are out of support.

In some implementations, different data types can be processed and tested at 220 and 225. For example, some files may be used for keys and certificates. In some instances, the files can be in a compressed file format of various types that can be processed in different ways corresponding to the data type. In some implementations, different processing and testing logic can be implemented for execution over different data types, such as certificate data (e.g., privacy enhanced mail (PEM) files and public and private distinguished encoding rules (DER) files), compressed data (e.g., zLib files, 7Zip files, LZ4 files, LZMA and YAFFS files), and file systems (e.g., could be embedded in a compressed file, such as 7Zip, LZMA or YAFFS file types, among other examples.

In some implementations, the assessment of the files associated with a firmware can be performed based on their type and specifics since there can be multiple files that can be of different types. Each of these file types may require specific code to extract the block of data related to the file type, and then execute code to extract data by either uncompressing the data of the file (different for each compression algorithm that may be associated with the file data), or expanding file systems (different for each type), and then analyzing the result data. In some instances, the result data, as read from the file, can be considered as another block of data that can be analyzed. In some instances, another iteration of the process can be applied to extract data at a lower level in the hierarchy of the files/data in the firmware. The processing of the data blocks can be performed until the data to the lowest level of the file hierarchy of the firmware. In some cases, if a filesystem is identified, the file system (e.g., a whole or a branch of a file system, such as LINUX filesystem) can be mounted on a temporary mount point on a device's operating system, and all the files identified in the mounted data can be analyzed.

In some implementations, the content 210 can be extracted from the source firmware 205 via an initial process that can use an implemented function (e.g., a scanning function) to read the source firmware 205 file and log hexadecimal start points of each separate discrete code module as a content item, store an offset for each separate code module, and store description information for the code module in a content list created for the source firmware 205. In some implementations, the list can be provided for processing by a function. The function can be implemented to check and determine each code module and look for content items (or data modules) that can be extracted. For example, extracted content items can be modules including certificate data, or compressed files in formats (e.g., in Zlib, Gzip, LZMA, or other formats). In some implementations, the identified content items can be copied during the extract 215 process to files. In particular, distinct files can be created that are uniquely identifiable and denoted, for example, as fDTa1, fDTd4, etc. In some implementations, the extraction of the content items can be performed programmatically by recording the hexadecimal offset value for the start of a content item and using the next content block start value to determine the number of bytes that should be extracted. The resulting data block can be named accordingly and stored in a file in a resulting filesystem (e.g., as shown at 222).

In some implementations, the extraction of compressed data from the source firmware 205 can be performed using programmed functions that extract compressed data and key information. In some implementations, embedded filesystems can be mounted depending on the type of the extracted file (e.g., also compressed file). For example, in the event that a data type of a file is determined to be a Private DER file, the key material can be read and accessed to determine a key type by checking for RSA, DSA, ECDSA, etc. Once a key type is determined, e.g., it is an RSA private key, applicable data extraction functions can be utilized to read the key material. In another example, if a data type of a file is identified as a compressed 7-Zip file, the content data can be decompressed (with a decompressing algorithm corresponding to the compressed type) and a file can be stored. If it was identified that the content is compressed, such identification of the data type can trigger a recursive check to identify additional data in files from the content of the uncompressed data.

In some implementations, the extracted files 215 can be associated with respective data types. The files 215 can be sorted according to the data types and different tests from the tests 225 can be executed for each respective set of files of a given data type. The processing 220 phase can be unique per content data type.

At 230, evaluation of test results based on the executed tests 225 can be performed and a security risk status can be determined based on rating the identified security issues. For example, the security risk status can be defined based on a rating scale. For example, the rating scale can include discrete statuses such as critical, high, medium, and low. However, other rating scales can be used as well. In some instances, the evaluation of the test results can be performed based on security rules that apply the logic of the rating to interpret the execution results from the tests. In some implementations, one or more rules can be defined to structure and aggregate data from the test results and generate the security risk status. In some instances, the test results can be processed according to logic that can be the same or different for the different sets of tests per data type of the test files.

In some instances, different data blocks may be processed based on different analytical techniques. For example, if a private DER file is extracted, the file may be analyzed to determine the type of cryptographic material (e.g., RSA/DSA/ECDSA) and then, specific tests may be applied to determine what information is available and how the file can be used. Such determination can provide results that can be used to determine a security rating or level. In some instances, different rules can be used to process data of different data types, where the rules can be updated regularly and/or at an update scheme or schedule, e.g., based on obtained input for changes in vulnerability awareness for risk factors for the particular data type over time.

In some instances, the tests 225 can include a predefined set of tests for multiple data types of files that can be included in source firmware 205 file. Tests can be selected to match the data types of the files extracted from the source firmware 205 that is currently being processed. The output of the test 225 execution can be used to assign risk classifications per data type and/or for the whole content of the source firmware 205.

In some implementations, an issues list can be compiled based on the executed tests 225, where the list can be used to generate a report 235 (e.g., in PDF or other file format). In some implementations, the report can include a command line report summary. In some instances, the command line report summary can be provided as an immediately viewable result that can be presented on a user interface displayed on a device screen for the user to provide information related to the risk factors associated with the tested firmware. In some instances, the summary can include risk rating (e.g., on a number scale or risk level scale such as high, medium, or low), a summary of the determining security issue/risk, and/or a location of the extracted firmware file on the device where the security risk assessment is performed (e.g., handheld device).

In some implementations, the method 200 includes an identification of various data types of files and the performance of extensive security assessment for each file extracted from the source firmware. In some cases, the extracted files can be mounted as a filesystem to a local drive for further analysis, for example, based on additional tests that may or may not include at least some of the tests 225.

In some examples, the mounting of the filesystem can be performed automatically. For example, many firmware files include specific operating system type filesystems including directories such as “/bin” and “/etc/”. In some implementations, a local mount point can be created in the results directory, where the identified filesystem can be mounted. Then, an evaluation similar to an “on-host audit” of the filesystem, permissions, versions, and configuration files, can be performed. In some instances, the security assessment may be performed to identify security issues, such as identifying misconfigurations in the mounted filesystem (e.g., permissions issues), plaintext passwords, and insecure network channels for communication.

FIG. 2B is a block diagram for an example method 250 for processing source firmware in accordance with implementations of the present disclosure. In some implementations, the example method 250 can be implemented as software running on hardware and can be provided as a service accessible over a network or as a mobile standalone device (e.g., as described in relation to FIG. 3).

In some implementations, the example method 250 can be implemented as an automated tool that executes multiple operations associated with a security risk analysis of a provided firmware file.

At 251, a source firmware file is obtained (e.g., through uploading by a user or providing by another service or application on a separate or same device).

At 252, content from the source firmware file is extracted. A plurality of files can be stored. The plurality of files comprises files dedicated to different data types, for example, as discussed in relation to the extraction 215 of FIG. 2A.

At 253, security test algorithms are executed on the plurality of files based on each data type of a file of the plurality of files. In some implementations, the files can be organized in groups based on their data type, and each group can be associated with a separate set of security tests. In some implementations, the security test algorithms include one or more security test algorithms specific to each different data type.

At 254, test execution results obtained based on the executed security test algorithms can be evaluated. For example, the test evaluation can be performed based on implemented security risk evaluation logic, including considerations of the security assessment of the various types of files.

At 255, a report is provided for display on a display device. The report can comprise a security risk status for the source firmware file determined based on the evaluation. In some implementations, the report can be substantially similar to the report 235 of FIG. 2A. The security risk status can include a rating of the security risk based on security issues associated with files from the plurality of files. The rating can be substantially the same as the rating 230 described in relation to FIG. 2A.

FIG. 3 is a block diagram of a handheld device 310 configured to evaluate security risks associated with a source firmware file provided by a user in accordance with implementations of the present disclosure. In some implementations, the handheld device 310 can include software that implements logic for executing security risk assessment of firmware files, for example, as described in relation to FIGS. 2A and 2B. In some implementations, the handheld device 310 can include device hardware 330 including processor(s), memory(s), battery(s), screen, or sensors. In some implementations, the handheld device 310 may run a device operating system 340 to provide an environment on top of which logic related to security risk assessment can be executed. For example, automated firmware security logic 350 can be executed over the device operating system 340, where the automated firmware security logic 350 can include operations to obtain content of a firmware source, extract content and store it into files, execute tests, and provide a security risk status (e.g., ranking and/or report summary). For example, the automated firmware security logic 350 may implement the method 200 or 250 of FIG. 2A or 2B. In some implementations, the automated firmware security logic 350 may store tests such as the test 225, where different tests may be available for different data types. In some instances, the test that can be utilized by the automated firmware security logic can be stored locally on the handheld device 310 (e.g., updated regularly to add more tests or modify existing tests). In some other instances, tests that are available for use by the automated firmware security logic 350 can be stored remotely, where upon receiving a request to process a source firmware, and determining data types associated with the requested source firmware, relevant tests for the determined data types can be invoked from the remote storage and maintained locally for local test execution.

In some implementations, the handheld device 310 can include a user interface 320 that can be a graphical user interface to be displayed on a screen of the handheld device 310 or remotely. In some implementations, a firmware file 305 can be provided to the handheld device 310 to initiate security risk assessment, for example, through the user interface 320. For example, the firmware file 305 can be provided by a user or another application or system to trigger a security scan. In some implementations, the firmware file 305 can be uploaded to the handheld device 310, for example, by selecting an upload file button 325 displayed on a user interface 320 of the handheld device 310. For example, the uploading can be performed by the user mounting a file from a connected device or over a network.

In some implementations, a security risk assessment can be started and/or interrupted through user interface buttons provided on the user interface 320. In some implementations, a progress bar 327 can be provided on the user interface 320 that can indicate the percent completion of the execution of the security risk assessment, for example, according to the operation as defined in the methods of FIG. 2A and/or 2B. In some implementations, the user interface can display a result rating of the firmware file 305, for example, such as the rating 230 of FIG. 2A. In some implementations, a report, such as report 235, can be provided as a link for further reference and review. In some instances, the report can be available for sharing via a made communication channel with another device or a destination point. In some implementations, the report can be made available for downloading to a removable media device that can be connected to the handheld device 310.

In some implementations, the handheld device 310 can be configured as a standalone analytical platform storing program code and providing a graphical user interface for display on a local screen. Such handheld device 310 can provide the advantages that advanced firmware analysis can be performed “in the palm of the user's hand,” in an isolated secure environment on dedicated hardware and software to provide immediate results. The execution of the tests can be performed locally and coordinated for the different data types. Tests for different data types can be executed as discrete processes that can be run simultaneously or sequentially (e.g., based on predefined logic for test execution and or intermediate test evaluation). The executed security risk assessment can provide results that can presented in a simple yet accurate format and can be processed by non-experts to determine whether to proceed with using the evaluated firmware on other devices. In some implementations, the execution of tests dedicated to one data type may provide results that can be considered before proceeding with execution of tests for another data type. In some implementations, if the results provided from a set of files of a given data type are above a threshold value for security risk level, subsequent tests for other files may be paused, and a risk rating can be provided to the user for review. In some implementations, the threshold value used for determining whether to pause subsequent test execution can be similar or different for different data types and can be associated with critical security risk status that when considered in combination with other test results (e.g., estimated result based on previous test executions or highest possible scores for security risk-free status for the other test) would result in a security risk rating above a second threshold value (e.g., similar or different than the first threshold value).

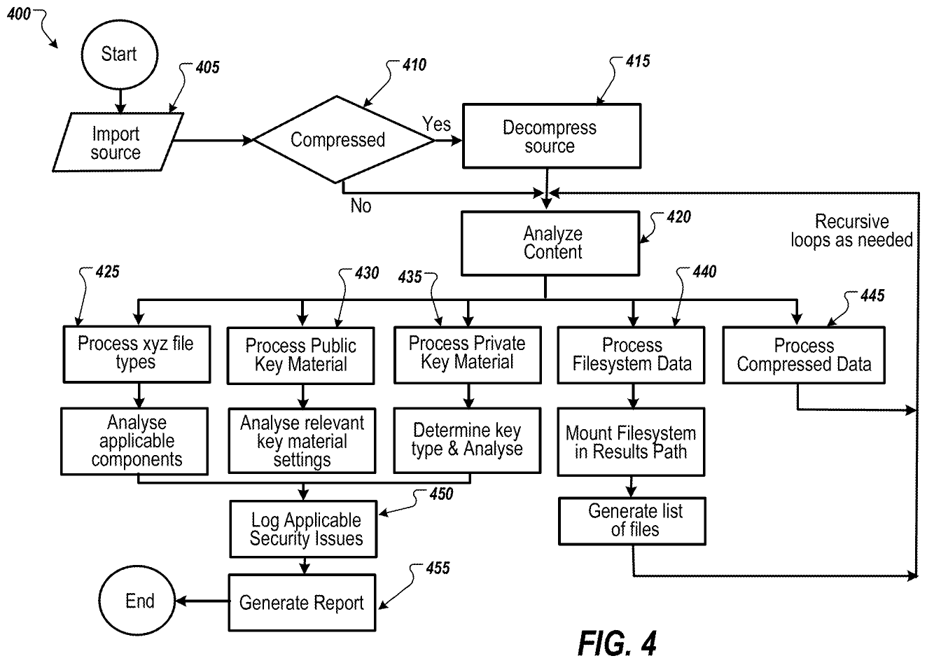

FIG. 4 is a flowchart for an example method 400 for analyzing content of a source firmware file to determine security issues in accordance with implementations of the present disclosure. In some implementations, the example method 400 can be executed as part of the logic of the automated firmware security logic 350 running on the handheld device 310 or can be executed as a service (e.g., a web or cloud services) provided by a server system. In some implementations, the example method 400 can be executed at a client device or a computer environment as discussed in relation to FIG. 1.

In some implementations, an import source 405 is received that includes a source firmware, such as the source firmware 205 of FIG. 2A, or the firmware file 305 of FIG. 3. At 410, it is determined whether the import source 405 is a firmware file that is in compressed format, and if it is, at 415, the compressed file is a decompressed to obtain the content of the compressed file. At 420, the content of the import source 405 is analyzed. In some implementations, the analysis of 420 can be substantially similar to the processing 220 and testing 225 as described in relation to FIG. 2A. In some implementations, the analysis performed at 420 can include separate processing branches (425, 430, 435, 440, and 445) directed to different data types of extracted content items from the content of the import source 405.

At 425, files of a particular data type “xyz” are processed, where applicable components are analyzed based on relevant tests for the data type “xyz.” At 430, public key material is processed and relevant key material settings are analyzed based on relevant tests for public key settings. At 435, private key material is processed, relevant key types are determined and analyzed based on relevant tests for private keys. At 440, file system data extracted from the content of the import source 405 is processed and mounted in a result path to generate a list of files that can be input to the analysis process at 420 and processed based on their respective data type (e.g., at a relevant branch from the branches 425, 430, 435, and 445). At 445, files that are in compressed format decompressed and their content is provided for analysis at 420.

Based on the executed analysis at 420, a log 450 of applicable security issues associated with the import source 405 can be provided that can be used to generate a report at 455. The generated report can be substantially similar to the report 235 of FIG. 2A. The report may include a rating of the security risk status of the import source 405.

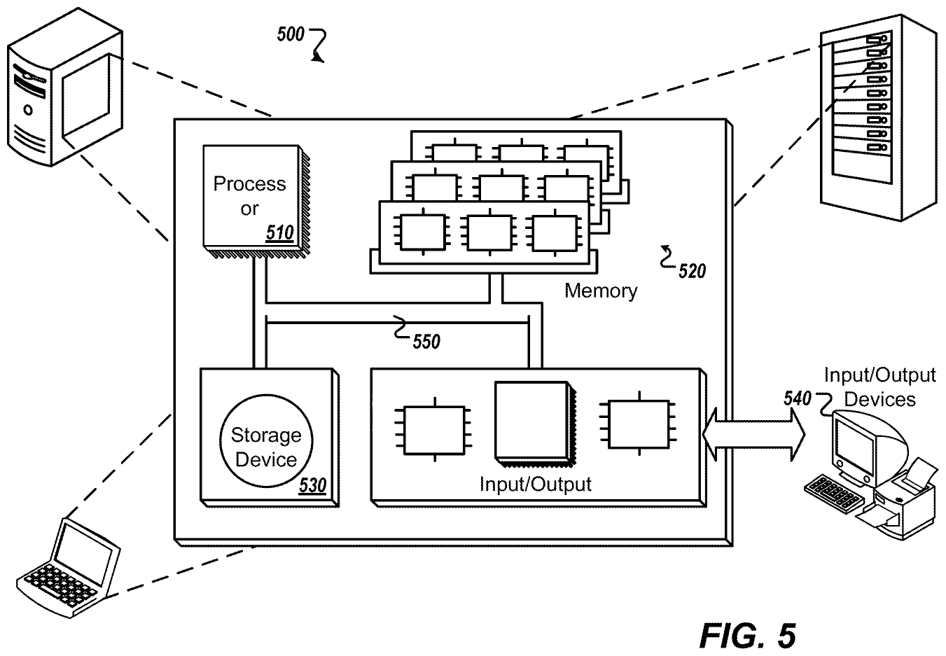

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, and 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system, including at least one programmable processor coupled to receive data and instructions from, and to transmit data and instructions to a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory, a random access memory, or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated into application-specific integrated circuits (ASICs).

To provide for interaction with a user, the features can be implemented on a computer having a display device, such as a cathode ray tube (CRT) or liquid crystal display (LCD) monitor for displaying information to the user and a keyboard and a pointing device, such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication, such as a communication network. Examples of communication networks include, for example, a LAN, a WAN, and the computers and networks forming the Internet.

The computer system can include clients and servers. A client and server are generally remote from each other and typically interact through a network, such as the described one. The relationship of the client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

In view of the above described implementations of the subject matter, this application discloses the following list of examples, wherein one feature of an example in isolation or more than one feature of said example taken in combination and, optionally, in combination with one or more features of one or more further examples are further examples also falling within the disclosure of this application.

What is claimed is:

1. A computer-implemented method for security assessment, the method comprising:
obtaining a source firmware file;
extracting content from the source firmware file and storing a plurality of files based on the extracted content, wherein the plurality of files comprises files respectively dedicated to different data types;
executing security test algorithms over the plurality of files based on each data type specific to each file of the plurality of files, wherein the security test algorithms comprise one or more security test algorithms specific to each different data type;
evaluating test execution results obtained based on the executed security test algorithms; and
providing a report for display at a display device, the report comprising a security risk status for the source firmware file determined based on the evaluation.

2. The method of claim 1, wherein extracting the content from the source firmware file comprises:
determining a list for discrete components identifiable by data type, wherein the list includes data for each discrete component comprising a starting point, an offset, and description; and
extracting, based on the determined list, the discrete components from the source firmware file to be stored as the plurality of files.

3. The method of claim 1, wherein providing the report comprising:
automatically generating the report based on one or more rules to structure and aggregate data provided from the evaluation of the test execution results and to generate the security risk status for the source firmware file; and
providing the report as a file for downloading via interaction with the display.

4. The method of claim 1, wherein extracting the content from the source firmware file comprises:
recursively extracting of components of the source firmware file, wherein one or more of the components are nested into a parent component of the components, wherein the recursive extracting comprises
determining whether the source firmware file is in a compressed form to execute decompression of the source firmware file to enable the recursive extraction.

5. The method of claim 1, wherein executing the security test algorithms comprises:
analyzing each of the plurality of files based on unique characteristics determined as related to a respective data type of one or more files of the plurality of files, wherein analyzing comprises
identifying one or more security tests relevant for a first data type, and
executing the one or more security tests for each of the first data types as a separate discrete process from a process for executing one or more other security tests for other files of another, second data type.

6. The method of claim 1, wherein evaluating the test execution results comprises:
identifying security alerts associated with at least one of the plurality of files.

7. The method of claim 1, wherein evaluating the test execution results comprises:
based on identifying security alerts associated with one or more files of the plurality of files, mounting the plurality of files as a filesystem at a local mount point to perform local audit of the filesystem, permissions, versions, and configuration files to determine security issues in the mounted filesystem.

8. The method of claim 7, wherein the determined security issues comprise misconfigurations in the filesystem related to setting permissions and/or insecure network communication channels.

9. A non-transitory computer-readable medium coupled to one or more processors and having instructions stored thereon which, when executed by the one or more processors, cause the one or more processors to perform operations, the operations comprising:
obtaining a source firmware file;
extracting content from the source firmware file and storing a plurality of files based on the extracted content, wherein the plurality of files comprises files respectively dedicated to different data types;
executing security test algorithms over the plurality of files based on each data type specific to each file of the plurality of files, wherein the security test algorithms comprise one or more security test algorithms specific to each different data type;
evaluating test execution results obtained based on the executed security test algorithms; and
providing a report for display at a display device, the report comprising a security risk status for the source firmware file determined based on the evaluation.

10. The non-transitory computer-readable medium of claim 9, wherein extracting the content from the source firmware file comprises:
determining a list for discrete components identifiable by data type, wherein the list includes data for each discrete component comprising a starting point, an offset, and description; and
extracting, based on the determined list, the discrete components from the source firmware file to be stored as the plurality of files.

11. The non-transitory computer-readable medium of claim 9, wherein providing the report comprising:
automatically generating the report based on one or more rules to structure and aggregate data provided from the evaluation of the test execution results and to generate the security risk status for the source firmware file; and
providing the report as a file for downloading via interaction with the display.

12. The non-transitory computer-readable medium of claim 9, wherein extracting the content from the source firmware file comprises:
recursively extracting of components of the source firmware file, wherein one or more of the components are nested into a parent component of the components, wherein the recursive extracting comprises
determining whether the source firmware file is in a compressed form to execute decompression of the source firmware file to enable the recursive extraction.

13. The non-transitory computer-readable medium of claim 9, wherein executing the security test algorithms comprises:
analyzing each of the plurality of files based on unique characteristics determined as related to a respective data type of one or more files of the plurality of files, wherein analyzing comprises
identifying one or more security tests relevant for a first data type, and
executing the one or more security tests for each of the first data types as a separate discrete process from a process for executing one or more other security tests for other files of another, second data type.

14. The non-transitory computer-readable medium of claim 9, wherein evaluating the test execution results comprises:
identifying security alerts associated with at least one of the plurality of files.

15. The non-transitory computer-readable medium of claim 9, wherein evaluating the test execution results comprises:
based on identifying security alerts associated with one or more files of the plurality of files, mounting the plurality of files as a filesystem at a local mount point to perform local audit of the filesystem, permissions, versions, and configuration files to determine security issues in the mounted filesystem.

16. A system comprising
a computing device; and
a computer-readable storage device coupled to the computing device and having instructions stored thereon which, when executed by the computing device, cause the computing device to perform operations, the operations comprising:
obtaining a source firmware file;
extracting content from the source firmware file and storing a plurality of files based on the extracted content, wherein the plurality of files comprises files respectively dedicated to different data types;
executing security test algorithms over the plurality of files based on each data type specific to each file of the plurality of files, wherein the security test algorithms comprise one or more security test algorithms specific to each different data type;
evaluating test execution results obtained based on the executed security test algorithms; and
providing a report for display at a display device, the report comprising a security risk status for the source firmware file determined based on the evaluation.

17. The system of claim 16, wherein extracting the content from the source firmware file comprises:
determining a list for discrete components identifiable by data type, wherein the list includes data for each discrete component comprising a starting point, an offset, and description; and
extracting, based on the determined list, the discrete components from the source firmware file to be stored as the plurality of files.

18. The system of claim 16, wherein providing the report comprising:
automatically generating the report based on one or more rules to structure and aggregate data provided from the evaluation of the test execution results and to generate the security risk status for the source firmware file; and
providing the report as a file for downloading via interaction with the display.

19. The system of claim 16, wherein extracting the content from the source firmware file comprises:
recursively extracting of components of the source firmware file, wherein one or more of the components are nested into a parent component of the components, wherein the recursive extracting comprises
determining whether the source firmware file is in a compressed form to execute decompression of the source firmware file to enable the recursive extraction.

20. The system of claim 16, wherein executing the security test algorithms comprises:
analyzing each of the plurality of files based on unique characteristics determined as related to a respective data type of one or more files of the plurality of files, wherein analyzing comprises
identifying one or more security tests relevant for a first data type, and
executing the one or more security tests for each of the first data types as a separate discrete process from a process for executing one or more other security tests for other files of another, second data type.
